(19) United States
(12) Patent Application Publication
(10) Pub. No.: US 2022/0046402 A1
(43) Pub. Date: Feb. 10, 2022

(54) APPARATUS, METHOD AND COMPUTER READABLE MEDIUM FOR SENDING AN EMERGENCY MESSAGE

(71) Applicant: ARRIS Enterprises LLC, Suwanee, GA (US)

(72) Inventors: Haiting Feng, Shanghai (CN); Lina Yang, Shanghai (CN); Zhenhui Lu, Shanghai (CN); Lijie Liu, Shanghai (CN); Weigang Zhou, Shanghai (CN)

(73) Assignee: ARRIS Enterprises LLC, Suwanee, GA (US)

(21) Appl. No.: 17/326,757

(22) Filed: May 21, 2021

(30) Foreign Application Priority Data
Aug. 6, 2020 (CN) 202010783373.6

(51) Int. Cl. H04W 4/90; H04W 4/12; H04W 4/21; H04N 21/478

(52) U.S. Cl. CPC H04W 4/90; H04N 21/478; H04W 4/21; H04W 4/12

(57) ABSTRACT

The present disclosure relates to a device, method and computer readable medium for sending an emergency message. A device for sending an emergency message through an apparatus installed with at least one communication application, the device comprises: a memory having instructions stored therein; a processor configured to execute the instructions stored on the memory so that the processor performs the following operations: receiving an emergency signal from a user; transmitting an emergency message to the at least one communication application in response to the received emergency signal; and sending, through the at least one communication application, the emergency message to contacts of the at least one communication application.

### TECHNICAL FIELD

The present disclosure generally relates to the field of communications technology. More specifically, this disclosure relates to a device, method and computer readable medium for sending an emergency message to the outside world through an apparatus connected to the network at home.

### BACKGROUND

With the increasing development of science and technology, more and more homes are deploying and using home network, so as to implement home intelligent information service (Intelligent Home). For example, TV system has gradually become the core unit of home intelligence. With its increasingly powerful processing capability and more and more functions, a TV set is able to realize greater value, and the new generation of TV sets can communicate with mobile phones, the Internet and other communication platforms, so as to meet the various daily needs of the users, and help users complete the management and monitoring of many family affairs for example.

The conventional assistance devices and systems for persons who need nursing care (for example, the elderly living alone or those with limited mobility) need to be set up separately or supervised manually, which is very cumbersome and costly. Therefore, it has been developed to use the TV sets with increasingly powerful processing capability that are currently in use at home, to assist people to achieve the functions of nursing and rescuing persons in need.

For example, in the related art, there already are many ways to provide assistance to the elderly living alone through the use of TV.

In Chinese Patent Application Publication No. CN104332035A, there is provided a method and a device for elderly people living alone to make emergency calls, which can help the elderly by use of communication between push to talk and a set-top box. By using this method, the elderly living alone cannot only watch network television and perform video communication at home, but also use the emergency call function to notify the service center or contact his/her relatives in case of emergency (no matter indoor or outdoor), which strengthens the care for the elderly people living alone. In case of emergency, the elderly people living alone can be assisted immediately, and serious consequences caused by the delay of treatment can be prevented, and the emergency treatment can be faster.

In Chinese Patent Application Publication No. CN204272322U, there is described an emergency call system based on intelligent network set-top box, the system comprises an intelligent network set-top box and a remote controller. The remote controller is a 2.4G wireless remote controller with an SOS button, the intelligent network set-top box is provided with a control unit which stores an emergency contact number and a public emergency phone number and is used for signal processing, a 2G/3G module used for calling the public emergency phone number or communicating with a collection terminal, and a USB interface with a USB receiving end inserted therein, the USB receiving end is used for communicating with the 2.4G wireless remote controller through a globally free 2.4 GHz channel. Therefore, with the intelligent network set-top box communicating with the remote control to make a phone call, it can make an emergency call, and at the same time inform family members by text messages.

In Chinese Patent Application Publication No. CN107948679A, there is described a help-seeking method and system based on Smart TV for the elderly. The method comprises the following steps: acquiring help-seeking information sent by the user's smart TV for the elderly; sending the help-seeking information to the online smart TVs for the elderly, residential community property management terminals and mobile terminals in the building where the user is located. If help information is not received within a pre-set time, then the help-seeking information is sent to the online smart TVs in other buildings in the residential community according to the distance, so that the elderly can get help in a timely manner.

In addition, in Chinese Patent Application Publication No. CN202110640U, there is also disclosed that a dedicated alarm program is installed in the television device, and is used for switching on or off the alarm function, setting and managing the detailed information of the rescue unit, processing the video/audio information of the person calling for help, automatically sending alarm information, dialing the emergency telephone number and performing other functions. Thus, automatic rescue and alarm can be realized as soon as possible in order to provide security assurance and reduce labor costs.

However, in the above-mentioned ways for providing assistance through the use of TV, if the person who needs to be rescued is unable to clearly describe the emergency situation in the emergency call due to his/her critical situation (for example, the elderly person is too sick to describe his/her condition), or the emergency contact person fails to answer the phone or see the message in time, then the person who needs to be rescued may not be able to get timely and effective rescue.

### SUMMARY

In view of the above problems, the technical scheme of the disclosure is proposed, which aims to send an emergency rescue message to as many contacts, perhaps as many as possible, quickly, so that the person in need can get rescued or assisted in time.

Some aspects of the present disclosure relate to a device for sending an emergency message through an apparatus installed with at least one communication application, and the device comprises: a memory having instructions stored therein; a processor configured to execute the instructions stored on the memory so that the processor performs the following operations: receiving an emergency signal from a user; transmitting an emergency message to the at least one communication application in response to the received emergency signal; and sending, through the at least one communication application, the emergency message to the contacts of the at least one communication application.

In some embodiments, the communication application includes a social software.

In some embodiments, the television system includes a set-top box (STB) or a television box.

In some embodiments, the television system includes an intelligent router.

In some embodiments, the emergency message includes a pre-written emergency message and/or an emergency message generated in real-time.

In some embodiments, further comprising program instructions for receiving the emergency signal from the remote controller through the STB, wherein the remote controller is provided with a special key, or one or more keys of the remote controller are programmed to send the emergency signal.

Some aspects of the present disclosure relate to a method for sending an emergency message through an apparatus installed with at least one communication application, and the method comprises: receiving an emergency signal from a user; transmitting an emergency message to the at least one communication application in response to the received emergency signal; and sending, through the at least one communication application, the emergency message to the contacts of the communication application.

In some embodiments, the communication application includes a social software.

In some embodiments, the television system includes a set-top box (STB) or a television box.

In some embodiments, the television system includes an intelligent router.

In some embodiments, the emergency message includes a pre-written emergency message and/or an emergency message generated in real-time.

In some embodiments, further comprising receiving the emergency signal from the television remote controller through the STB, wherein the remote controller is provided with a special key, or one or more keys of the remote controller are programmed to send the emergency signal.

Some aspects of the present disclosure relate to a non-transitory computer-readable medium for use with an apparatus installed with at least one communication application, and the non-transitory computer-readable medium has instructions stored therein for execution by a processor to perform the steps of the method according to the present disclosure.

Some aspects of the present disclosure also relate to a device for sending an emergency message through an apparatus installed with at least one communication application, the device includes components for performing steps of the method according to the present disclosure.

Some aspects of the present disclosure relate to a set-top box, which comprises a device for sending an emergency message through an apparatus installed with at least one social software as in the present disclosure.

Some aspects of the present disclosure relate to an intelligent router, which comprises a device for sending an emergency message through an apparatus installed with at least one social software as in the present disclosure.

By using the embodiments of the present disclosure, the emergency help-seeking message can be quickly sent to many people, perhaps as many as possible, so as to enable the person in need of rescue to be rescued timely and effectively.

### BRIEF DESCRIPTION OF THE DRAWINGS

In order to better understand the present disclosure and show how to realize the present disclosure, it will now be described with reference to the accompanying drawings by way of example, wherein:

FIG. 1 is a schematic block diagram illustrating a device according to an embodiment of the present disclosure.

FIG. 2 is a flowchart illustrating a method according to an embodiment of the present disclosure.

FIG. 3 is a schematic diagram illustrating a system according to an embodiment of the present disclosure.

FIG. 4 is a schematic diagram illustrating the topology of an example home network.

FIG. 5 is a composition block diagram illustrating a device according to another embodiment according to the present disclosure.

Note that like reference numerals refer to corresponding parts throughout the drawings. Moreover, multiple instances of the same part are designated by a common prefix separated from an instance number by a dash.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

### First Embodiment

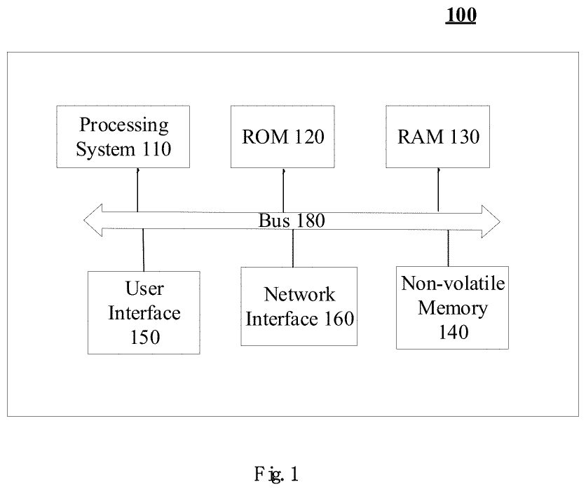

FIG. 1 is a schematic block diagram illustrating a device 100 according to an embodiment of the present disclosure. The device 100 in FIG. 1 is used for sending emergency message to the outside world through an apparatus preferably installed with at least one communication application. The device 100 comprises a processing unit 110, one or more memories utilized by the processing system 110 (such as read only memory (ROM) 120, random access memory (RAM) 130, and/or nonvolatile memory 140), a user interface 150 and a network interface 160. All these components are connected to each other via a bus 180.

The processing system 110 controls the general operations of the device 100. The processing system 110 can include, but is not limited to, a CPU, a hardware microprocessor, a hardware processor, a multi-core processor, a single core processor, a microcontroller, an Application Specific Integrated Circuit (ASIC), a DSP, or other similar processing device capable of executing any type of instructions, algorithms, or software for controlling the operation and functions of the device 100 in accordance with the embodiments described in the present disclosure. The processing system 110 may be various implementations of digital circuitry, analog circuitry, or mixed signal (a combination of analog and digital) circuitry that perform functionalities in a computing system. The processing system 110 may include, e.g., such a circuit like an Integrated Circuit (IC), portions or circuits of an individual processor core, an entire processor core, an individual processor, a programmable hardware device such as a Field Programmable Gate Array (FPGA), and/or a system including a plurality of processors.

The one or more memories include, but are not limited to, the Read Only Memory (ROM) 120, the Random Access Memory (RAM) 130 and the non-volatile memory 140 as shown in FIG. 1, and a Dynamic Random Access Memory (DRAM), a Static Random Access Memory (SRAM), an EPROM, an EEPROM, a flash memory, logic blocks of a FPGA, hard disk, or any other various layers of memory hierarchy which are not shown in the figure.

In addition, for example, the nonvolatile memory 140 can include program instructions for controlling the general functions and operations of the device 100. The program instructions are configured for sending an emergency message through a television system, wherein the television system is installed with at least one communication application. The program instructions comprises program instructions for receiving an emergency signal from a user; program instructions for transmitting an emergency message to the at least one communication application in response to the received emergency signal; and program instructions for sending, through the at least one communication application, the emergency message to a contact of the communication application.

The user interface 150 can include various apparatus for interaction between the user and the device 100, including, but not limited to, a remote control, a voice input apparatus such as a microphone, and a video input apparatus such as a camera, and so on (as will be described in detail later).

The network interface 160 may include various network cards, and circuitry implemented in software and/or hardware to enable communications with the outside world using wireless protocols, such as any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, or 6 GHz bands, RF4CE protocol, ZigBee protocol, Z-Wave protocol, or IEEE 802.15.4 protocol.

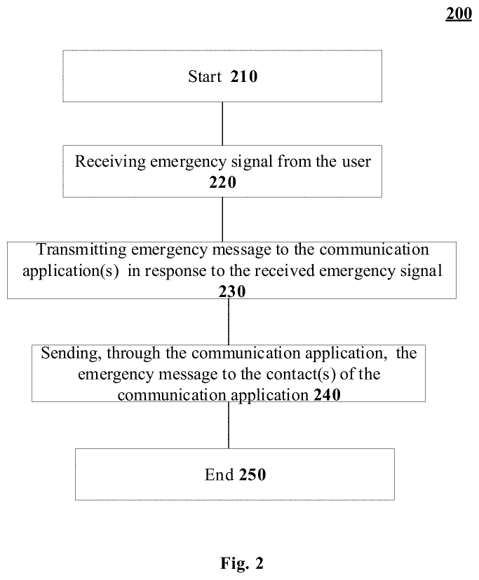

Next, a method 200 according to an embodiment of the present disclosure will be described with reference to FIG. 2. Method 200 is used for sending emergency message to the outside world through an apparatus preferably installed with at least one communication application. Method 200 begins with Step 210 and then proceeds to step 220. In step 220, an emergency signal is received from a user through the apparatus preferably installed with at least one communication application. Then, in step 230, in response to the received emergency signal, an emergency help-seeking message is transmitted to the at least one communication application. Next, in Step 240, the emergency help-seeking message is sent, through the communication application, to the contact(s) of the communication application(s). The method in FIG. 2 ends in step 250.

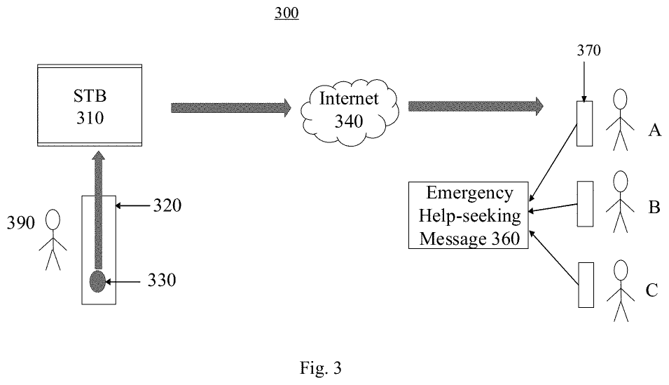

FIG. 3 is a schematic diagram illustrating a system 300 according to an embodiment of the present disclosure.

In the system 300, the afore-mentioned apparatus may be a set-top box (STB) 310, for example. It could be any type of STB commercially available on the market, such as a network STB or a TV box. The STB 310 is installed with communication tool(s)/application(s). Preferably, the communication tool(s)/application(s) include various social software, including, but not limited to, WeChat, QQ, TikTok, MOMO, Facebook, Twitter, WhatsApp, Instagram, etc. However, as will be readily appreciated by a person skilled in the art, such communication applications as text message or email are also applicable to the present disclosure.

The STB 310 may be equipped with a remote controller 320. The remote controller 320 can be provided with a special key 330, so that a user 390 can press it when necessary, thereby sending an emergency signal to the STB 310. Alternatively, an emergency signal can be sent to the STB 310 by combining or programming the existing keys on the remote controller 320. For example, a pre-set long pressing time for a specific key can be specified (for example, a long press of the number 1 key for 10 seconds), so as to indicate that an emergency signal will be sent. Thus, upon receiving a long press on the number 1 key, an emergency signal will be sent to the STB 310. According to another embodiment, an emergency signal can also be sent to the STB 310 by using a combination of several keys.

In addition, the present disclosure is not limited to using remote controller 320 to send the emergency signal to the STB 310. For example, existing devices such as landline phones and cordless phones (or other types of devices in a smart home) can also be adapted to be able to communicate with the STB 310. Thus, when specific key(s) (or a combination thereof) on an existing device such as the landline telephone or the cordless telephone is pressed in a predetermined manner, the emergency signal can also be sent to the STB 310.

The STB 310 may be connected to the Internet 340 either wired or wirelessly, using the communication protocols as described in the foregoing.

Moreover, the STB 310 may store a pre-written emergency help-seeking message in advance. When the STB 310 receives an emergency signal from the user 390 as described above, the STB 310 extracts the pre-stored emergency help-seeking message 360 and transmits the message to one or more of the installed social software. Preferably, the installed social software is always open, in order to receive such emergency help-seeking messages at any time. The pre-written emergency help-seeking messages stored in advance can include: preset text, picture, audio and video, and so on.

However, according to other embodiments of the present disclosure, instead of using the emergency help-seeking messages stored in advance, the STB 310 can also, upon receipt of the emergency signal, start immediately the connected input apparatus (such as a microphone or a camera) and record audio or capture pictures and/or videos in real-time, and transmit the audio, pictures and/or video generated in real-time to one or more of the installed social software. In addition, according to another embodiment of the present disclosure, both the emergency help-seeking messages stored in advance and the messages generated in real-time can be transmitted to one or more of the installed social software at the same time, so as to be sent to the contact(s) thereof. In addition, it is known to a person skilled in the art as to how to connect such apparatus as the microphone and camera to the STB 310, and the details thereof will be omitted.

When the emergency help-seeking message 360 is received, for example the installed social software sends the message to predetermined contacts thereof (for example, users A, B, and C in FIG. 3). The contacts can be pre-determined in a variety of ways. For example, it can be specified that a “Moment” message (as in WeChat), so that the message can be sent to a wide range of recipients. Alternatively, it can be specified that the message is sent to one or more family members or medical staffs.

A specific application instance for sending emergency message via the system 300 according to an embodiment of the present disclosure will be described below. When the user 390 (for example, an elderly person living alone or a person with limited mobility) suddenly feels uncomfortable while watching TV, he can send an emergency signal to the STB 310 by pressing a special key 330 or long pressing a certain key on the remote controller 320 for example. Upon receiving such a signal, the STB 310 extracts a pre-written emergency help-seeking message or generates in real-time an emergency help-seeking message, and sends, via social software, such messages to the contact(s) thereof on the Internet. One or more of the contacts may be using their smart phones or other client 370 and seeing such a help-seeking message, then they can quickly rescue the user 390. Compared with the conventional ways of using push to talk or an emergency contact, by means of the embodiments of the present disclosure, the help-seeking message can be sent to for example as many contacts as possible in a short time, so that the rescue can be implemented more quickly and effectively.

In addition, as readily appreciated by a skilled person, in the system 300, the STB 310 can be a separated apparatus, or it can be connected to or integrated within a TV set, so as to form a smart TV and perform the operations as described herein.

Although the embodiment of the present disclosure is described above with an elderly person living alone or a person with limited mobility as an example, as can be understood by those skilled in the art, the embodiment of the present disclosure is not limited to this, but can be applied to any situation where an emergency help-seeking message needs to be sent to as many contacts as possible quickly. For example, in the case of fire, earthquake, burglary, etc., the present disclosure is also applicable.

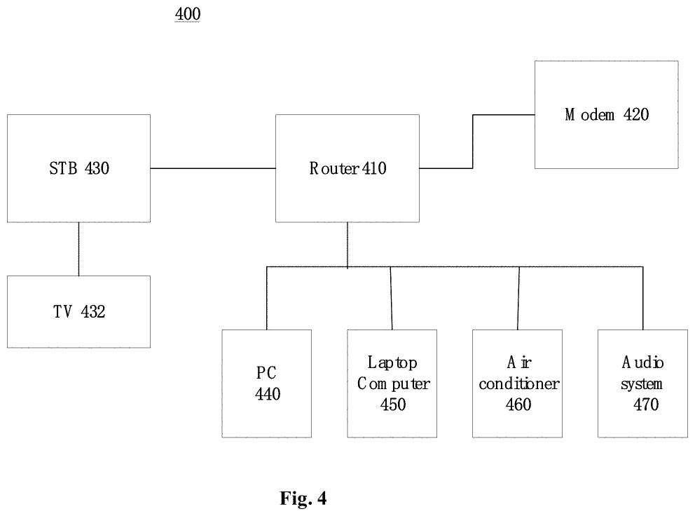

Additionally, as can be appreciated by a skilled person, the system 300 can be part of a home network. FIG. 4 illustrates the schematic topology of a home network 400.

The home network 400 can include a router 410, a modem 420, a STB 430, a TV 432 possibly connected to the STB 430, and various household electrical appliances possibly connected to the router 410, including (but not limited to) a PC 440, a laptop computer 450, an air conditioner 460 and an audio system 470 and so on. As can be appreciated by a skilled person, the electrical appliances connected to the home network 400 as shown in FIG. 4 are only schematic, other appliances than those shown here can be connected to the home network 400 as necessary.

In the topology of FIG. 4, as can be appreciated by a skilled person, the STB 430 can be used as a communication platform, when the data exchange format and network configuration among the various electrical appliances connected are uniform, the STB 430 can be used to control the electrical appliances connected to the home network 400 uniformly. For example, the remote control of the STB 430 can be used to control the operations of the above-mentioned various electrical appliances.

Under this circumstance, according to some embodiments of the present disclosure, the STB 430 can be similar to the STB 310 as shown in FIG. 3, preferably installed with at least one communication application/tool (for example, the social software). When an emergency signal is received from the user, the emergency message can be sent to the respective contact(s) through the social software. Alternatively, according to other embodiments of the present disclosure, instead of installing the communication application/tool (for example, the social software) in the ST 430, the communication application/tool can be installed in the various electrical appliances connected to the STB 430 or the router 410. For example, when an emergency signal is received from the user via the remote control of the STB 430, the emergency message can be sent to the respective contact(s) through the social software installed in an electrical appliance controlled by the STB 430.

As can be seen, when applied in home network 400, any electrical appliance connected to the home network 400 can be used to send an emergency message to the outside, as long as the electrical appliance can be installed with at least one communication application.

### Second Embodiment

Above the first embodiment of the present disclosure is described basically by taking the STB, the smart TV or both as an example. However, the present disclosure is not limited to this. According to the second embodiment of the present disclosure, the STB 310 in the first embodiment may be replaced by an intelligent router (not shown), to perform the operations of the present disclosure.

For example, the intelligent router or the various electrical devices connected to the intelligent router can be installed with at least one communication application (e.g., social software), so that the user can send emergency message to the outside through the communication application installed on the intelligent router or the various electrical devices connected to the intelligent router, so as to get rescued or assisted in a timely manner.

In the second embodiment, the rest of the compositions and operations are the similar to those in the first embodiment, therefore, the details thereof will be omitted.

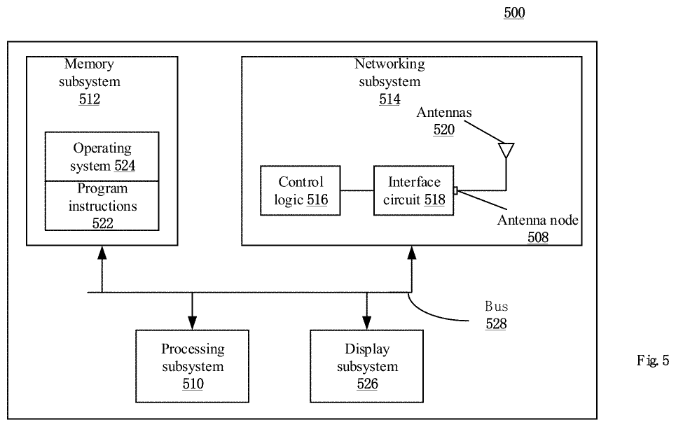

We now describe another embodiment of the device according to the present disclosure, which may perform at least some of the operations in the communication techniques. FIG. 5 presents a block diagram illustrating an example of a device 500 according to some embodiments. The device 500 according to the present disclosure may include a processing subsystem 510, a memory subsystem 512 and a networking subsystem 514. The processing subsystem 510 includes one or more devices configured to perform computational operations. For example, the processing subsystem 510 may include one or more microprocessors, ASICs, microcontrollers, programmable-logic devices, graphics processor units (GPUs), and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory (which collectively or individually are sometimes referred to as a ‘computer-readable storage medium’). In some embodiments, instructions for processing subsystem 510 in memory subsystem 512 include: one or more program modules or sets of instructions (such as program instructions 522 or operating system 524), which may be executed by processing subsystem 510. Note that the one or more computer programs may constitute a computer-program mechanism. Moreover, instructions in the various modules in memory subsystem 512 may be implemented in: a high-level program language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments, device 500 includes one or more nodes, such as node 508, e.g., a pad, which can be coupled to the one or more antennas 520. Thus, device 500 may or may not include the one or more antennas 520.) For example, networking subsystem 514 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of device 500 may be adapted or changed by using pattern shapers (such as reflectors) in one or more antennas 520 (or antenna elements), which can be independently and selectively electrically coupled to ground to steer the transmit antenna radiation pattern in different directions. Thus, if one or more antennas 520 includes N antenna-radiation-pattern shapers, the one or more antennas 520 may have 2N different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 4 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, device 500 may use the mechanisms in networking subsystem 514 for performing simple wireless communication between the electronic devices, e.g., transmitting frames and/or scanning for frames transmitted by other electronic devices.

Within the device 500, processing subsystem 510, memory subsystem 512, and networking subsystem 514 are coupled together using bus 528. Bus 528 may include an electrical, optical, and/or electro-optical connection that the subsystems can use to communicate commands and data, and so on. Although only one bus 528 is shown for clarity, different embodiments can include a different number or configuration of electrical, optical, and/or electro-optical connections among the subsystems.

In some embodiments, device 500 includes a display subsystem 526 for displaying information on a display, which may include a display driver and the display, such as a liquid-crystal display, a multi-touch touchscreen, etc.

Device 500 can be (or can be included in) any electronic device with at least one network interface. For example, device 500 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, test equipment, and/or another electronic device.

Although specific components are used to describe device 500, in alternative embodiments, different components and/or subsystems may be present in device 500. For example, device 500 may include one or more additional processing subsystems, memory subsystems, networking subsystems, and/or display subsystems. Additionally, one or more of the subsystems may not be present in device 500. Moreover, in some embodiments, device 500 may include one or more additional subsystems that are not shown in FIG. 5. Also, although separate subsystems are shown in FIG. 5, in some embodiments, some or all of a given subsystem or component can be integrated into one or more of the other subsystems or component(s) in device 500. For example, in some embodiments, program instructions 522 are included in operating system 524 and/or control logic 516 is included in interface circuit 518.

Moreover, the circuits and components in device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 514. The integrated circuit may include hardware and/or software mechanisms that are used for transmitting wireless signals from device 500 and receiving signals at device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

While the preceding discussion used Wi-Fi and/or Ethernet communication protocols as illustrative examples, in other embodiments, a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively or additionally, at least some of the operations in the communication techniques may be implemented in a physical layer, such as hardware in interface circuit 518.

The present disclosure may be implemented as any combination of a device, a system, an integrated circuit, and a computer program on a non-transitory computer readable recording medium. The one more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described above and in the drawings. For example, the one or more memories stores software or algorithms with executable instructions and the one or more processors can execute a set of instructions of the software or algorithms in association for performing operations in any number of wireless networks in accordance with the embodiments described in the present disclosure.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term “computer-readable medium” refers to any computer program product, device or apparatus, such as a magnetic disk, optical disk, solid-state storage device, memory, and programmable logic devices (PLDs), used to provide machine instructions or data to a programmable data processor, including a computer-readable medium that receives machine instructions as a computer-readable signal.

By way of example, a computer-readable medium can comprise dynamic random access memory (DRAM), random access memory (RAM), read-only memory (ROM), electrically erasable and programmable read-only memory (EEPROM), compact disc read-only memory (CD-ROM) or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

Similarly, while operations are depicted in the drawings in a particular order, this should not be understood as requiring that such operations be performed in the particular order shown or in sequential order, or that all illustrated operations be performed, to achieve desirable results. In some cases, multitasking and parallel processing may be advantageous.

1. A device for sending an emergency message through an apparatus installed with at least one communication application, the device comprises:
a memory having instructions stored therein;
a processor configured to execute the instructions stored on the memory, so that the processor performs the following operations:
receiving an emergency signal from a user;
transmitting an emergency message to the at least one communication application in response to the received emergency signal; and
sending, through the at least one communication application, the emergency message to contacts of the at least one communication application.

2. The device according to claim 1, wherein the communication application includes a social software.

3. The device according to claim 1, wherein the apparatus includes a set-top box (STB) or a TV box.

4. The device according to claim 1, wherein the apparatus includes an intelligent router.

5. The device according to claim 1, wherein the emergency message includes a pre-written emergency message and/or an emergency message generated in real-time.

6. The device according to claim 3, further comprising program instructions for receiving the emergency signal from the remote controller through the STB, wherein the remote controller is provided with a special key, or one or more keys of the remote controller are programmed to send the emergency signal.

7. A method for sending an emergency message through an apparatus installed with at least one communication application, said method comprises:
receiving an emergency signal from a user;
transmitting an emergency message to the at least one communication application in response to the received emergency signal; and
sending, through the at least one communication application, the emergency message to contacts of the at least one communication application.

8. The method according to claim 7, wherein the communication application includes a social software.

9. The method according to claim 7, wherein the apparatus includes a set-top box (STB) or a TV box.

10. The method according to claim 7, wherein the apparatus includes an intelligent router.

11. The method according to claim 7, wherein the emergency message includes a pre-written emergency message and/or an emergency message generated in real-time.

12. The method according to claim 9, further comprising receiving the emergency signal from the remote controller through the STB, wherein the remote controller is provided with a special key, or one or more keys of the remote controller are programmed to send the emergency signal.

13. A non-transitory computer-readable medium for use with an apparatus, wherein the apparatus is installed with at least one communication application, said non-transitory computer-readable medium has instructions stored therein for execution by a processor to perform the steps of claim 7.

14. A device for sending an emergency message through an apparatus installed with at least one communication application, said device comprises means for performing the steps of the method according to claim 7.

15. A set-top box, comprising the device according to claim 1.

16. An intelligent router, comprising the device according to claim 1.
